(19) United States
(12) Patent Application Publication
(10) Pub. No.: US 2005/0097065 A1
(43) Pub. Date: May 5, 2005

(54) System and method for analyzing relationships between sourcing variables

(75) Inventors: Blake Johnson, Del Mar, CA (US); Dario Benavides, Cupertino, CA (US); Heiko Pieper, Mountain View, CA (US); Colin Kessinger, Menlo Park, CA (US); Allan Gray, Los Altos, CA (US); Antje Kann, San Francisco, CA (US)

Correspondence Address: CARR & FERRELL LLP, 2200 GENG ROAD, PALO ALTO, CA, 94303, US

(73) Assignee: Vivecon Corporation

(21) Appl. No.: 11/009,435

(22) Filed: Dec. 9, 2004

Related U.S. Application Data
(63) Continuation-in-part of application No. 10/269,794, filed on Oct. 11, 2002.
(60) Provisional application No. 60/528,454, filed on Dec. 9, 2003.

(51) Int. Cl. G06F 17/60; G06F 17/00; G06G 7/00

(52) U.S. Cl. 705/400; 705/37; 705/1

(57) ABSTRACT

A system and method is provided for analyzing relationships between sourcing variables. A condition is defined utilizing one or more sourcing variables. One or more sourcing performance scenarios that satisfy the condition are identified. At least one relationship between the one or more sourcing variables is defined. The at least one relationship is then analyzed utilizing the one or more identified sourcing performance scenarios. The results of the analysis may be refined with further conditions, relationships, and/or sourcing performance scenarios.

### CROSS-REFERENCES TO RELATED APPLICATIONS

The present application is a continuation-in-part of U.S. patent application Ser. No. 10/269,794 filed on Oct. 11, 2002 and entitled “System and Method for Automated Analysis of Sourcing Agreements and Performance;” the present application also claims the benefit and priority of U.S. provisional patent application No. 60/528,454 filed Dec. 9, 2003 and entitled “System and Method for Analyzing Relationships Between Sourcing Variable,” both of which are incorporated herein by reference.

The present invention is also related to U.S. patent application Ser. No. 10/621,645 filed on Jul. 17, 2003 and entitled “System and Method for Representing and Incorporating Available Information into Uncertainty-Based Forecasts” and U.S. patent application Ser. No. 10/621,726 filed Jul. 17, 2003 and entitled “System and Method for Optimizing Sourcing Opportunity Utilization Policies,” which are herein incorporated by reference.

### BACKGROUND OF THE INVENTION

1. Field of the Invention

The present invention relates generally to material sourcing, and more particularly, to a system and method for analyzing relationships between sourcing variables.

2. Description of Related Art

Proper management of material sourcing policies and structuring of material sourcing agreements is a huge challenge to virtually every business. Typically, costs of sourcing materials and services comprise 30-70% of revenue and drive the business' gross margin. Material costs, inventory, and availability are key sourcing related business performance metrics. Thus, the business must constantly balance costs with inventory and availability. For example, the business may have an option of purchasing a particular material at a relatively low price. However, if the business cannot turn around and sell the material or a by-product of the material relatively quickly, the business is then required to store the material, leading to storage costs and reduced working capital. Alternatively, if the business has reason to believe that future availability of the item is low and thus will result in an increased price for the material, the high storage cost and reduced capital may be acceptable and more feasible in the long term.

Conventionally, businesses are faced with various sourcing risks including price risk, availability risk, and demand risk. Uncertain or inaccurate forecasts can lead to demand risks, while uncertainty of prices leads to price risk. If demand is high for an item, then the price is generally higher, and the converse is true. However, one cannot predict with precise certainty demands of a market. Finally, an uncertainty in supply leads to an availability risk. Supply uncertainty may include capacity shortages, quality problems, supplier allocation decisions, and delivery disruptions. Supply uncertainty is also related to demand and price uncertainty. For example, the higher the demand, the higher the costs and likelihood that availability is lower. All of these sourcing risks define the potential profitability of the business.

Accordingly, businesses must structure supply agreements in such a way as to optimize future business performance. However, proper structuring of supply agreements requires a business to identify a range of possible demands, prices, and supply forecast scenarios, and to assign probabilities of likelihood to these scenarios. Generally, a plurality of scenarios should be developed including, for example, base, high, and low scenarios. In this most basic example, the base scenario is a standard forecast, while high and low scenarios capture the uncertainty around the base forecast. Any desired number of additional scenarios may be developed for special or unique circumstances which may affect price, demand, and supply of the material. The complete set and distribution of these scenarios may be represented mathematically as stochastic processes, with appropriate correlation structure between the processes representing each uncertainty. Once these scenarios have been developed, then steps must be taken to reduce sourcing uncertainty and improve economic performance.

One method for reducing sourcing uncertainty is for a business to evaluate sourcing variables. Specifically, the relationships and interactions between sourcing circumstances, objectives, decisions, and performance should be clearly understood before, during, and/or after implementation of these sourcing agreements. Further, these variables are also important to understand with respect to implementation of sourcing agreement utilization policies (also referred to as “sourcing opportunity utilization policies”). However, relationships and interactions between these sourcing variables are complex due to their multi-dimensional nature. Thus, a method is needed for effectively analyzing the relationships between sourcing variables. Such a method will be extremely valuable because the understanding provided can be used to improve decisions and to more accurately assess determinants and consequences.

### SUMMARY OF THE INVENTION

The present invention provides in various embodiments a system and method for analyzing relationships between sourcing variables. According to one embodiment, a condition is defined utilizing one or more sourcing variables. Next, one or more sourcing performance scenarios that satisfy the condition are identified. At least one relationship between the one or more sourcing variables is defined for analysis. The relationship is then analyzed utilizing the one or more identified sourcing performance scenarios.

In a system according to one embodiment of the present invention, a data generation engine defines a condition of interest utilizing one or more sourcing variables and defines at least one relationship between the sourcing variables. The data generation engine also identifies one or more sourcing performance scenarios that satisfy the condition. A database coupled to the data generation engine stores the one or more variables and the one or more sourcing performance scenarios. Further, an analytical engine coupled to the database analyzes the relationship between the one or more sourcing variables utilizing the one or more identified sourcing performance scenarios.

Users can then revise or refine either the condition or the relationship(s)/interaction(s). If the results suggest that a new or different condition and/or associated relationship(s)/interaction(s) merit evaluation, new or different conditions may be defined. Alternatively, a new relationship of interest may be defined and the analysis reprocessed. By identifying one or more additional conditions, the user can evaluate more relationships and interactions associated with the sourcing variables. Alternatively, if the results suggest that data from a greater number of scenarios that satisfy the condition will allow accuracy or completeness of the results to be improved, additional scenarios that satisfy the condition can be generated using the sourcing performance analysis, and the additional scenarios can be used to supplement the analysis. Relevant relationship(s) or interaction(s) can then be analyzed over the expanded set of scenarios.

A further understanding of the nature and advantages of the inventions herein may be realized by reference to the remaining portions of the specification and attached drawings.

### BRIEF DESCRIPTION OF THE DRAWINGS

FIG. 1 is a schematic diagram showing an exemplary architecture for analyzing relationships between sourcing variables;

FIG. 2 is a schematic diagram showing an exemplary scenario generation engine;

FIG. 3 is a schematic diagram showing an exemplary analytical engine;

FIG. 4 is a schematic diagram showing an exemplary analysis output engine; and

FIG. 5 is a flowchart describing a process for analyzing relationships between sourcing variables, according to an embodiment of the present invention.

### DESCRIPTION OF THE EXEMPLARY EMBODIMENTS

The present invention provides a system and method for analyzing relationships between sourcing variables. These sourcing variables may be utilized in the sourcing opportunity utilization policy system of related U.S. patent application Ser. No. 10/269,794.

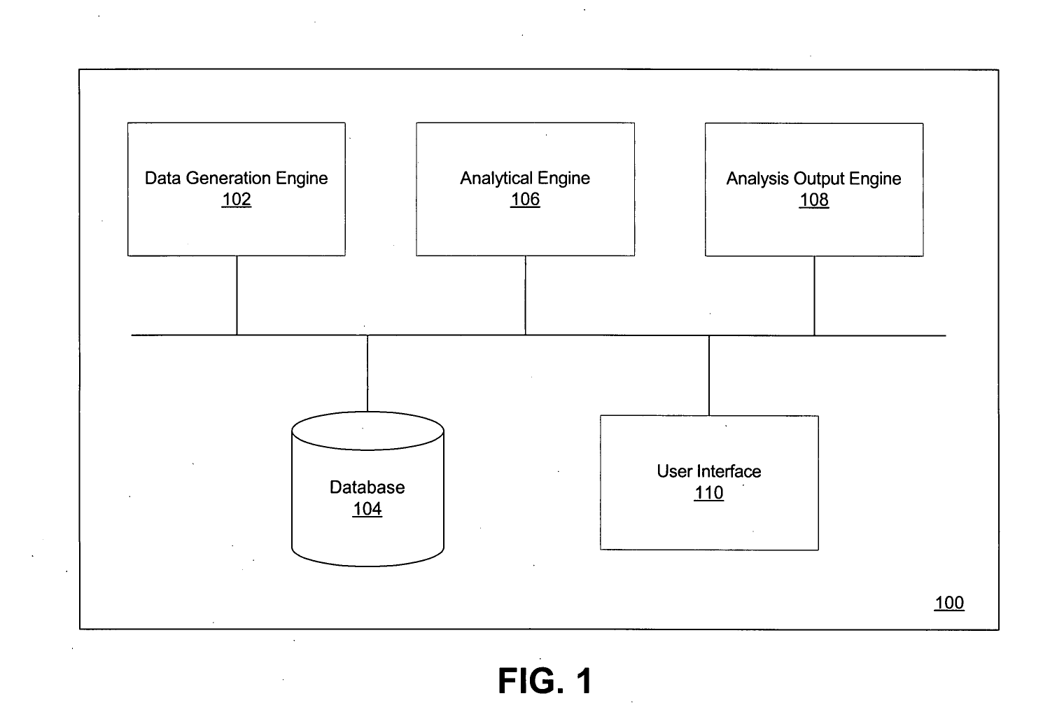

Referring now to FIG. 1, a schematic diagram of an exemplary architecture 100 for analyzing relationships between sourcing variables is shown. According to one embodiment, the exemplary architecture 100 comprises a data generation engine 102, at least one database 104, an analytical engine 106, and an analysis output engine 108. The architecture 100 may also comprise a user interface 110 which allows the user to view and refine the results of the sourcing variable analysis. Each of the engines of FIG. 1 will be discussed in further detail below.

In exemplary embodiments, the data generation engine 102 creates data and/or selects existing data (e.g., sourcing performance scenarios) from the database 104 based on user supplied criteria. These supplied criteria define conditions of interest. For example, a user may wish to evaluate all sourcing performance scenarios that achieve less than 30 days of inventory under lower demand conditions. If new or additional sourcing performance scenarios or other data need to be generated that satisfy the condition of interest, the database generation engine 102 or attached systems (e.g., U.S. patent application Ser. No. 10/269,794, “System and Method for Automated Analysis of Sourcing Agreements and Performance”) will generate the data. Any newly created data from the data generation engine 102 may then be stored in the database 104.

Once created or selected, the data from the database 104 is forwarded to the analytical engine 106 for processing. Subsequently, the analytical engine 106 transmits processed data to the analysis output engine 108, which packages the data for output to the user interface 110. For instance, the analysis output engine 108 may create a graph for outputting the data, a summary of the data, and so forth. The analysis output engine 108 may output the data in any manner suitable for use with the present invention.

The database 104 comprises various data including sourcing variables. Sourcing variables may comprise properties or characteristics of sourcing circumstances, objectives, decisions, performance, and functions related to other sourcing variables. In other words, sourcing variables may represent any feature or aspect related to sourcing performance. These sourcing variables may be at individual points in time, averaged values, changes over time (e.g., trends, cycles, or measures of variance), and performance relative to benchmark values. Any type of sourcing performance variable is within the scope of the present invention. For instance, the sourcing variable may be a circumstance such as demand, supply price, supply availability, capacity, and quality. Further sourcing variables may comprise supplier status and performance (e.g., financial status or delivery capability), inventory (e.g., storage costs and capacity), and shortage (e.g., cost of delivery delay, lost sale, or damaged customer relationship). In further examples, the sourcing variable may be buyer or supply decisions or performance (e.g., timing and amount of orders placed or shipped, quantity of material commitment not honored by supplier or buyer). Alternatively, the sourcing variable may be a combination of factors. For example, the sourcing variable may be a combined inventory and shortage measure.

Other existing data in the database may comprise sourcing. performance scenarios. In exemplary embodiments, all of the data about sourcing variables as described above will be attached to sourcing performance scenarios. Sourcing performance scenarios may be represented mathematically as stochastic processes. Typically, sourcing performance scenarios represent data given a specified set of parameters. For example, a sourcing performance scenario may be data regarding a demand for pork bellies from Northern California between January 2001 to January 2002, and associated values of related sourcing variables. Any sourcing performance scenario suitable for use with the present invention may be employed. In one embodiment, the sourcing performance scenarios are generated according to the system and method described in co-pending U.S. patent application Ser. No. 10/269,794 entitled “System and Method for Automated Analysis of Sourcing Agreements and Performance”. This system and method stores the necessary information in a database allowing the data to be transferred directly to the database 104. Additionally the data may be entered into the database 104 directly as a result of output of prior analyses done by the analytic engine 106 or manually entered by the user. Finally, data such as forecasts and historical data may be captured from other databases through system integration mechanisms.

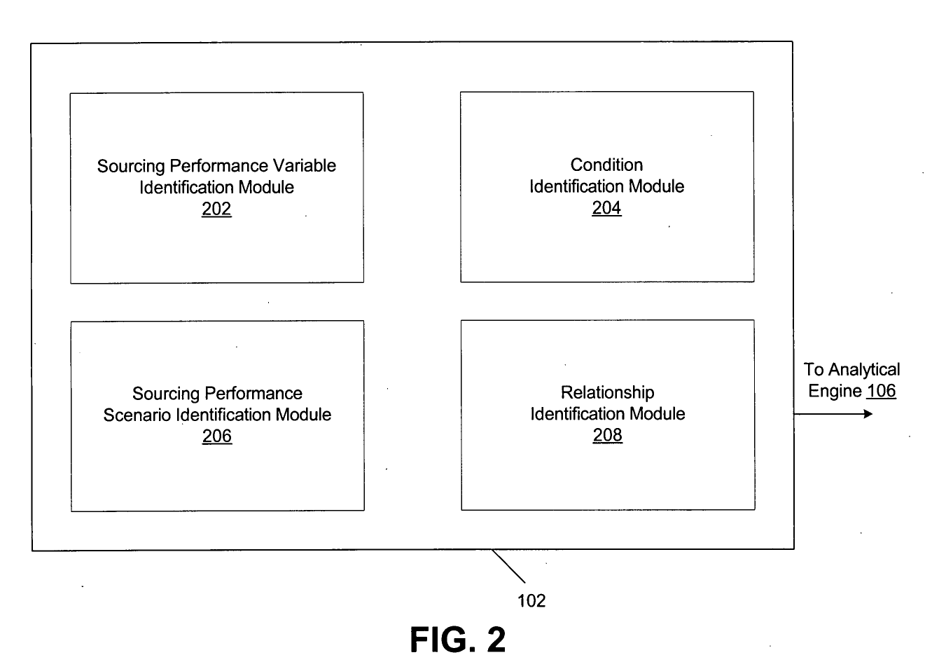

As discussed herein, data stored in the database 104 may comprise sourcing performance scenarios, values of associated sourcing variables, and conditions of interest. Conditions of interest represent conditions and circumstances that a user may choose to research, and are discussed further in connection with FIG. 2. Sourcing variables, sourcing performance scenarios, and conditions of interest may be selected from existing data in the database 104, or they may be generated by the data generation engine 102 or other functionally equivalent engine, and stored in the database 104. Typically, in order to generate the sourcing performance scenario, condition of interest, and so forth, the user selects or creates variables pertinent to the particular sourcing performance scenario, condition of interest, etc. Examples of sourcing performance scenarios and conditions of interest that incorporate variables are discussed herein. However, any type of data may be stored in the database 104 according to the present invention.

It should be noted that the exemplary architecture 100 of FIG. 1 illustrates one embodiment. Alternative embodiments may comprise more, less, or other functionally equivalent engines. For example, although only one database 104 is shown in FIG. 1, alternative embodiments may comprise a plurality of databases (e.g., one database for storing conditions of interest and one database for storing sourcing performance scenarios).

Referring now to FIG. 2, a schematic diagram of an exemplary data generation engine 102 is shown. The exemplary data generation engine 102 comprises a sourcing performance variable identification module 202, a condition identification module 204, a sourcing performance scenario identification module 206, and a relationship identification module 208. Alternative embodiments may comprise more modules, less modules, other modules, and/or functionally equivalent modules. The exemplary sourcing performance variable identification module 202 identifies sourcing variables by selecting the sourcing variables from the existing data in the database 104 (FIG. 1) and/or by creating sourcing variables defined as a function of one or more sourcing variables in the database 104. In a simple application, the user can select the sourcing variables from a pre-defined set of sourcing variable made available to him/her in the sourcing performance variable identification module 202. Alternatively, the sourcing performance variable identification module 202 can enable the user to define the sourcing variable by using a predefined set of functions and restricted by available data in the system. For example, the use may wish to define new sourcing variables (e.g., averages over time and materials, or quarterly performance instead of monthly performance).

The sourcing variables selected by the sourcing performance variable identification module 202 are then utilized by the condition identification module 204 to identify a condition of interest according to one embodiment of the present invention. More than one condition of interest may be identified in accordance with the present invention. As discussed herein, a condition of interest may represent any condition, scenario, or question that the user wishes to examine. In one embodiment, a particular condition of interest may be selected from a list of conditions of interest identified and presented to the user via the user interface 110 (FIG. 1). Alternatively, the user may select or enter the condition of interest via the user interface 110.

The sourcing performance scenario identification module 206 identifies at least one sourcing performance scenario that satisfies the condition of interest identified by the condition identification module 204 and/or selected by the user. Many sourcing performance scenarios under which the condition is satisfied may be identified. For example, there may be a variety of sourcing performance scenarios that satisfy the condition “less than 5% shortages under high demand conditions.”

The exemplary relationship identification module 208 defines a relationship between the sourcing variables to be analyzed utilizing the sourcing performance scenarios identified by the sourcing performance scenario identification module 206. The relationship between sourcing variables can be an interaction between the sourcing variables, circumstances, objectives, and/or performance that impact the sourcing variables, for example. Any type of relationship between sourcing variables is within the scope of the present invention.

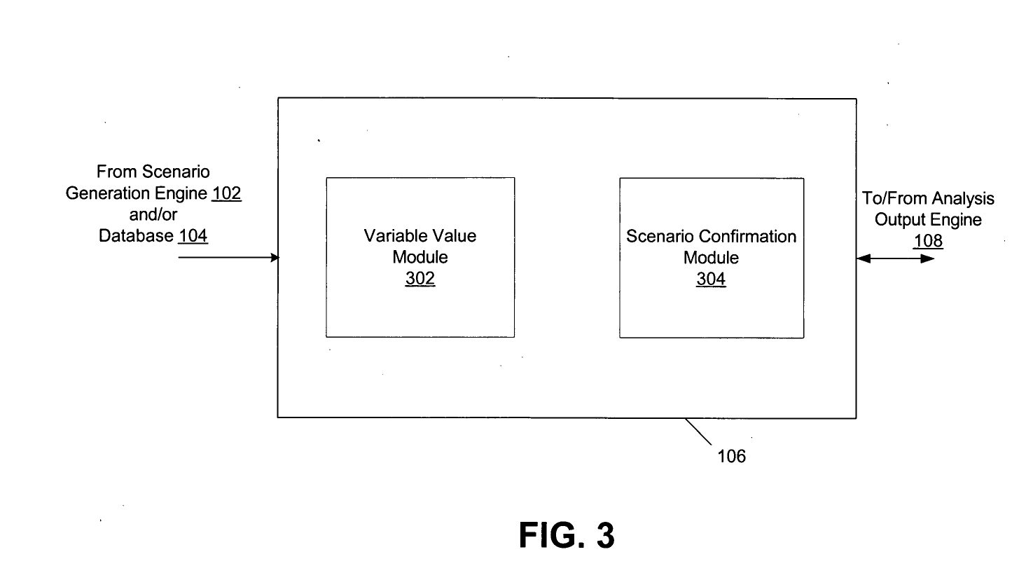

Referring now to FIG. 3, a schematic diagram of the exemplary analytical engine 106 is shown. According to one embodiment, the analytical engine 106 comprises a variable value module 302 and a scenario confirmation module 304. The exemplary variable value module 302 evaluates the values of the sourcing variables identified by the sourcing performance variable identification module 202 (FIG. 2). In exemplary embodiments, the evaluation comprises organizing (e.g., averaging, repackaging, etc.) the variable values according to the condition of interest. For example, if the variable values received from the sourcing performance variable identification module 202 are based on monthly results and the condition of interest is concerned with quarterly performance, then the variable value module 302 will reorganize the variable values into quarterly results. In further embodiments, the evaluations are performed to error check and pre-process the variable values and sourcing performance scenarios before actual analysis begins.

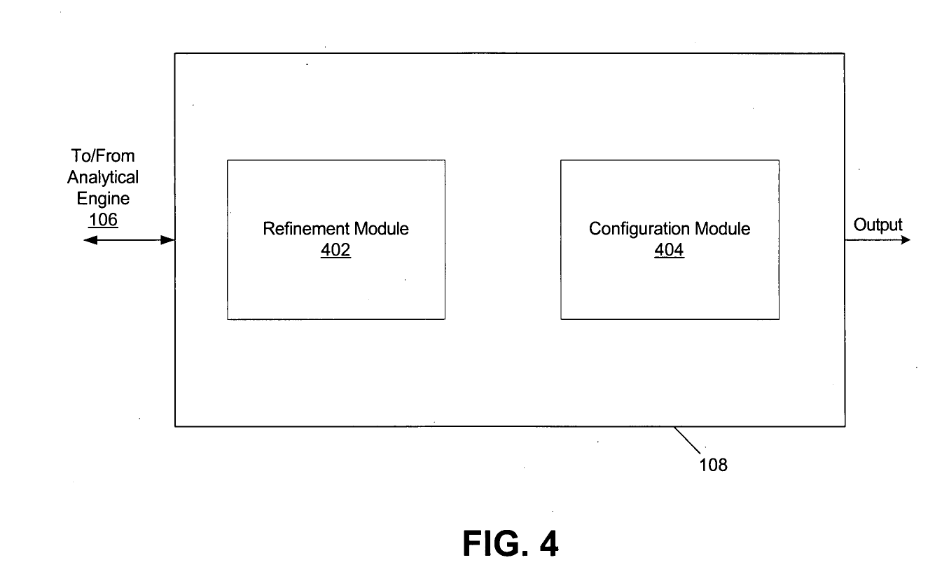

The scenario confirmation module 304 confirms that the sourcing performance scenarios identified by the sourcing performance scenario identification module 206 (FIG. 2) represent the condition of interest identified by the condition identification module 204 (FIG. 2) based on the evaluation of the sourcing variable values by the variable value module 302. If the sourcing performance scenarios identified do not accurately represent the condition of interest, additional, replacement, and/or a subset of sourcing performance scenarios can be identified by the refinement module (FIG. 4). For example, the user or system reviews a “first cut” set of sourcing performance scenarios identified to represent the condition of interest. If the set of sourcing performance scenarios is not exactly what the user wants, then, the process proceeds to the refinement module to define a new, more appropriate condition. For example, the user may specify a condition that average shortages must be less than 5%. A query may return 50 scenarios, some of which have an average of 5% but a worst-case of 20% and others that have an average of 5% and a worst case of 10%. In the refinement process, the user may add the additional condition that the worst case scenario cannot exceed 10%.

Referring now to FIG. 4, a schematic diagram of an exemplary analysis output engine 108 is shown. According to one embodiment, the analysis engine 108 comprises a refinement module 402 and a configuration module 404. The exemplary refinement module 402 utilizes the results from the analytical engine 106 (FIG. 1) to determine whether other areas of analysis are appropriate. The refinement module 402 may identify further conditions of interest, supplemental sourcing performance scenarios, and so forth. Additionally, the refinement module 402 may also extend analysis to include a broader spectrum by including the supplemental sourcing performance scenarios, conditions of interest, etc. For example, assuming that the initial analysis from the analytical engine 106 reveals that under high demand, the objective of limiting expedited material orders to 10% or less of purchases is binding a large percentage of the time, the further question “are shortages more common and/or larger in size on the sourcing performance scenarios where the constraint is binding than when it is not?” may need to be answered. This supplemental data may be forwarded to the analytical engine 106 by the refinement module 402 for analysis utilizing the processes discussed herein.

Optionally, the configuration module 404 may configure the data analyzed for output. The configuration module 404 may select an output presentation type and formats the data according to the presentation type. For example, if the data analyzed is in graph and/or chart format, the configuration module 404 conforms the data to the graph and/or the chart format for display via the user interface 110 (FIG. 1). In a further example, in order to create a historgram to compare multiple sourcing performance scenarios, the configuration module 404 will have to visually optimize the graph by creating data buckets and by sizing an axis.

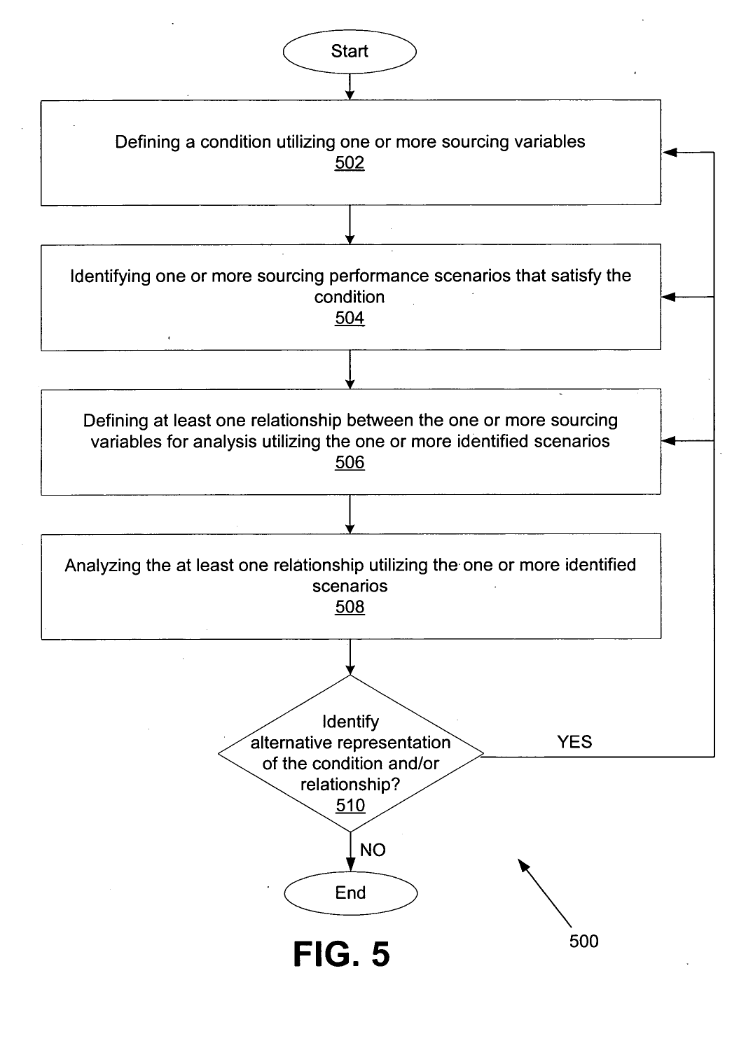

Referring now to FIG. 5, a flowchart 500 for an exemplary process for analyzing relationships between sourcing variables is shown. At step 502, at least one condition is defined utilizing one or more variables. As described above, the user may either define the condition directly, or select from a list of pre-defined conditions. According to one embodiment, the at least one condition is defined by the condition identification module 204 (FIG. 2). Each condition may be an interaction or a relationship between sourcing variables, or a series of interactions or relationships between variables, which is of interest to a user. For example, the user may have an interest in a “demand is high” condition. In other words, the user has an interest in understanding the relationship and/or interaction between variables when demand for a material, service, product, etc. is high.

One or more sourcing variables may be selected to represent the condition of interest and the associated relationship(s) or interaction(s) of interest (discussed in more detail at step 508). As discussed herein, sourcing variables may be properties and/or characteristics of circumstances, objectives, decisions, and/or performance associated with sourcing. The condition of interest and the associated relationship or interaction of interest may be defined by specified values of the variable(s) or by functions of the variable(s). Specifically, through the user interface 110 (FIG. 1), the user first defines the sourcing variables of interest and then specifies the conditions (the definition of the conditions may depend on what type of variable the user defines) to be met, according to one embodiment. In an alternative embodiment, the condition is first identified and then the sourcing variables of interest are defined. Alternatively, the exemplary system may allow for both embodiments to be performed (i.e., determination of condition or sourcing variables of interest first followed by the determination of the sourcing variable or condition of interest, respectively).

At step 504, at least one scenario that represents the condition of interest is identified. Thus, the variable values for each scenario of the relevant sourcing performance analysis are analyzed to identify those scenarios, if any, on which the variable values satisfy the condition of interest as defined. In one embodiment, the scenario identification is performed by the sourcing performance scenario identification module 206 (FIG. 2). Using the example above, one or more scenarios that satisfy the “demand is high” condition are identified. If there is no scenario for which the variable values satisfy the condition of interest as defined, this result is recorded, and, if relevant, the process is repeated with a revised or alternative condition of interest.

At step 506, a relationship between the one or more variables is defined for analysis utilizing the at least one scenario identified in step 504. In exemplary embodiments, the relationship is defined by the relationship identification module (FIG. 2). For example, under definitions of the “demand is high” condition, such as the “demand at a specified point in time exceeds a specified level,” the one or more sourcing variables used to define these relationships or interactions may not involve any of the one or more sourcing variables used to define the condition, itself. Alternatively, it may be of interest to evaluate the probability distribution of demand levels when the condition “demand is high” is satisfied, for example, in which case the one or more sourcing variables used to specify the relationship or interaction may include specifically the one or more sourcing variables also utilized to define the condition. As another example, it may be of interest to evaluate one or more properties or functions of the joint distribution between demand and inventory levels and/or shortage levels when demand is high. In this case, both the one or more sourcing variables utilized to define the condition as well as one or more additional sourcing variables may be used to specify the relationship or interaction.

At step 508, the relationship is analyzed utilizing at least one scenario. Step 508 assumes that at least one scenario has been identified in step 504 under which the sourcing variable values satisfy the condition as defined. The relationship(s) or interaction(s) of interest are analyzed for each such scenario using the sourcing variable values for those scenarios or functions thereof, as appropriate. For example, the relationship of interest may be supplier performance on alternative forms of supply agreements when demand is high or material availability levels when demand is high. The variables utilized to define the condition may be the same variables utilized to define the relationship or they may be different variables, as discussed herein. Thus, once the condition is defined, the relationship analysis is a three step process performed by the relationship identification unit 208 (FIG. 2) to identify the relationship, the variable value module 302 (FIG. 3) to compute the metric (i.e., sourcing variable), and the configuration module 404 (FIG. 4) to generate charts that demonstrate the relationships.

Optionally, at step 510, the results of the analysis in step 508 may be utilized to identify an alternative representation of the condition or of the relationship(s)/interaction(s), to guide the refinement of the analysis of the prior condition or relationship/interaction, or to identify at least one other condition or relationship(s)/interaction(s) of interest. According to exemplary embodiments, step 510 is performed by the refinement module 402 (FIG. 4).

The user may choose to identify an alternative representation of the condition or the relationship(s)/interaction(s), if the results of the analysis of the condition or relationship(s)/interaction(s) as currently represented reveal that an alternative representation would have greater or incremental value. For example, the results may suggest that representing the “demand is high” condition using average demand over the analysis period is not sufficiently specific, and that evaluating the condition and relevant relationship(s) and interaction(s) for specific time intervals or points in time would provide greater or incremental value. Alternatively, the results may suggest that the lead time of supply agreements has a greatest impact on material availability when demand is high, and as a result that revising or refining the relationship(s) or interaction(s) being evaluated to better explore this relationship would be valuable.

The user can accomplish the revision or refinement of either the condition or the relationship(s) or interaction(s) by repeating steps of the flowchart 500 to continue the refinement process. For example, if the results suggest that a new or different condition and associated relationship(s)/interaction(s) merit evaluation, the user can return to step 502 in order to define the new or different condition. Alternatively, the user can return to step 506 to define a new relationship of interest, and then continue the analysis process. By identifying one or more additional conditions, the user can evaluate more relationships and interactions associated with the sourcing variables.

If the results suggest that data from a greater number of scenarios that satisfy the condition would allow accuracy or completeness of the results to be improved, additional scenarios that satisfy the condition can be generated using the sourcing performance analysis, and the additional scenarios can be used to supplement the analysis. Relevant relationship(s) or interaction(s) can then be analyzed over the expanded set of scenarios. Thus, in the high demand condition example, the user can generate more scenarios that meet the high demand condition and then calculate the values of the relevant variables for those scenarios. This type of iteration provides an ability to dynamically tailor statistical accuracy of results to desired levels.

Optionally, the definition of the condition may be refined by utilizing at least one of the one or more variables. For instance, the definition of the “demand is high” condition may be further refined by specifying that the condition occurs at a specific point in time, over a specific time interval or set of time intervals, and so forth. For example, the user may want to understand the “demand is high” condition during the summer months. Another way of stating this is that the user wants to understand what other circumstances, objectives, performance, decisions, etc. may arise if the user's company, for example, experiences a high demand for its product during the months of June, July, and August. The user may specify any number of stipulations associated with the defined condition that are suitable for use with the present invention, such as, for example, the aforementioned point in time, a level of the material price, or a level of inventory.

For instance, the condition “demand is high” may be defined to occur whenever the value of demand at a specified point in time exceeds a specified level. Alternatively, this condition may be defined to occur whenever the average level of demand over a specified time interval is in the top 10% of all such average levels of demand over the specified time interval. Other sets of variables may be selected for defining the condition further and/or for introducing additional factors relating to the condition, relationship(s), or interaction(s) of interest.

Other sets of variables may introduce additional defining circumstances, such as shortage cost or inventory levels, or defining decisions, such as how materials are sourced under the high demand conditions. These sets of variables may be utilized to refine the relationship(s) or interaction(s) initially defined. As discussed herein, these variables can serve as, or be used to construct, conditions and/or relationships and interactions of interest.

In operation, the present invention allows for the determination of causes and consequences of decisions regarding sourcing conditions. Relationships between inputs and/or outputs can be evaluated to present information to the user that helps the user to better understand options and outcomes associated with specified sourcing conditions. As discussed herein, the variables to be considered and analyzed with respect to the condition may relate to circumstances, objectives, decisions, performance, or any combination thereof. Any variable suitable for use with the present invention may be included for analysis. Further, the user may specify any level of detail desired with respect to the analysis. For example, management may be more interested in summary metrics such as average performance over an extended time period, across an aggregated value of multiple performance measures, or with agreement negotiations, may want to drill down to look at more detailed sourcing variables, such as performance at specific points in time or on individual performance measures, etc. Moreover, the level of detail may change depending on the results output to the user. Accordingly, the user can manage the details in order to enhance the user's understanding of the results and potential continued analysis.

The present invention has been described above with reference to exemplary embodiments. It will be apparent to those skilled in the art that various modifications may be made, and other embodiments can be used, without departing from the broader scope of the invention. For example, any data described as being user-input may actually be fed from another source such as on-line data from the Internet, coupled enterprise applications, or another supplied database. Therefore, these and other variations upon the exemplary embodiments are intended to be covered by the present invention.

1. A method for analyzing relationships between sourcing variables, comprising:
defining a condition utilizing one or more sourcing variables;
identifying one or more sourcing performance scenarios that satisfy the condition;
defining at least one relationship between the one or more sourcing variables; and
analyzing the at least one relationship utilizing the one or more identified sourcing performance scenarios.

2. The method of claim 1, further comprising utilizing the analysis to define at least one further condition.

3. The method of claim 1, further comprising utilizing the analysis to define at least one further relationship.

4. The method of claim 1, further comprising utilizing the analysis to identify at least one further sourcing performance scenario.

5. The method of claim 1, further comprising determining one or more values associated with the one or more sourcing variables.

6. The method of claim 1, further comprising confirming that the one or more identified sourcing performance scenarios satisfy the condition.

7. The method of claim 1, wherein the condition is represented by a query.

8. A system for analyzing relationships between sourcing variables, comprising:
a data generation engine configured for identifying one or more sourcing variables for defining a condition and for identifying one or more sourcing performance scenarios that satisfy the condition;
a database coupled to the data generation engine and configured for storing the one or more variables and the one or more sourcing performance scenarios; and
an analytical engine coupled to the database and configured for analyzing at least one relationship between the one or more sourcing variables utilizing the one or more sourcing performance scenarios identified.

9. The system of claim 8, further comprising an analysis output engine configured for outputting analysis of the at least one relationship between the one or more variables.

10. The system of claim 9, wherein the analysis output engine further comprises a refinement module configured for defining a further condition based on the analysis of the relationship between the one or more sourcing variables.

11. The system of claim 9, wherein the analysis output engine further comprises a refinement module configured for defining a further relationship between the one or more sourcing variables based on the analysis of the relationship between the one or more sourcing variables.

12. The system of claim 8, wherein the data generation engine further comprises a sourcing performance scenario identification module configured for identifying at least one further sourcing performance scenario based on the analysis of the relationship between the one or more sourcing variables.

13. The system of claim 8, wherein the data generation engine further comprises a sourcing variable identification module configured for identifying the one or more sourcing variables.

14. The system of claim 8, wherein the data generation engine further comprises a sourcing performance scenario identification module configured for identifying the one or more sourcing performance scenarios.

15. The system of claim 8, wherein the data generation engine further comprises a relationship identification module configured for identifying the relationship between the one or more sourcing variables.

16. The system of claim 8, wherein the data generation engine further comprises a condition identification module configured for defining the condition according to the one or more sourcing variables.

17. The system of claim 8, wherein the analytical engine further comprises a variable value module configured for defining one or more values associated with the one or more sourcing variables.

18. The system of claim 8, wherein the analytical engine further comprises a scenario confirmation module configured for confirming that the one or more sourcing performance scenarios represent a defined condition.

19. The system of claim 8, wherein the data generation engine further comprises a sourcing performance scenario identification module configured for identifying at least one further sourcing performance scenario based on a need to generate more scenarios that satisfy the condition

20. A computer-readable medium comprising instructions for analyzing relationships between sourcing variables by performing the steps of:
defining a condition utilizing one or more sourcing variables;
identifying one or more sourcing performance scenarios that satisfy the condition;
defining at least one relationship between the one or more sourcing variables; and
analyzing the at least one relationship utilizing the one or more identified sourcing performance scenarios.

21. An apparatus for analyzing relationships between sourcing variables, comprising:
means for defining a condition utilizing one or more sourcing variables;
means for identifying one or more sourcing performance scenarios that satisfy the condition;
means for defining at least one relationship between the one or more sourcing variables; and
means for analyzing the at least one relationship utilizing the one or more identified sourcing performance scenarios.
